(19) United States
(12) Patent Application Publication
(10) Pub. No.: US 2015/0100502 A1
(43) Pub. Date: Apr. 9, 2015

(54) SYSTEM AND METHOD FOR PITCHING AND EVALUATING SCRIPTS

(71) Applicant: Tunnls LLC, Longbeach, CA (US)

(72) Inventor: Terris Woodard, Longbeach, CA (US)

(21) Appl. No.: 14/510,084

(22) Filed: Oct. 8, 2014

Related U.S. Application Data
(60) Provisional application No. 61/888,413, filed on Oct. 8, 2013.

(51) Int. Cl. G06Q 10/10; G06Q 50/00

(52) U.S. Cl. CPC G06Q 10/101; G06Q 50/01
USPC 705/300

(57) ABSTRACT

A computer implemented system and method used to facilitate the upload, evaluation, and submission of a script is disclosed. The system and method include a first server, the first server configured to receive a script uploaded by a user, and a processor, either associated with the server or operably connected to the server, the processor adapted to review the script, wherein the processor reviews the script: automatically in comparison to a master script including benchmark data associated therewith, and/or manually, wherein one or more users of the system review the script via the processor; and/or manually, wherein one or more industry users of the system review the script via the processor.

### CROSS REFERENCE TO RELATED APPLICATION

The present application claims the benefit of U.S. Provisional Patent Application Ser. No. 61/888,413, filed Oct. 8, 2013, the entirety of which is hereby incorporated by reference.

### BACKGROUND

The entertainment industry has a world, language, and lifestyle of its own that persons in that industry are passionate about. Although major entertainment hubs (i.e. Nashville, Hollywood) are seemingly one large physical social network for persons in the entertainment industry, there has yet to be a social network designed for this industry.

Television shows, movies, plays, teleplays, and other performance art are built from scripts. Today, producers usually review and purchase stories through treatments, a title logline and synopsis of a script. Producers rarely read entire scripts and, if they do, the author usually has already paid to write the script. In some instances, an author with a preexisting script is required to generate a treatment for producer review rather than hand over the entire script. The issue is that producers lack the time to review scripts in their entirety and generally make decisions based on treatments. Of course, if a producer really likes a treatment and a full script is available, the producer might read the script to determine whether to pursue the project.

A problem with this approach is that an author's treatment may not accurately portray his or her work such that a producer is truly equipped to make a decision regarding the underlining script. In addition, creating a treatment may take a great deal of time for an author as he or she is required to review the entire script manually and rewrite sections for purposes of the synopsis portion of the treatment.

Moreover, producers usually review treatments independently and make decisions based on their personal feel for the success any individual treatment. With no social aspect to treatment review, producers may greenlight projects that are uninteresting to the general public and be far into the process before realizing it.

Accordingly, there exists a need for a network-capable social platform which facilitates an efficient submission collection of scripts and generation of treatment-like reviewable products from scripts to interested parties, such as agents, producers, and studio representatives, and for an efficient means for the interested parties to access and evaluate the scripts for potential production either collectively or independently.

### BRIEF DESCRIPTION OF THE DRAWINGS

FIG. 1 illustrates a flowchart of a method for pitching and evaluating scripts according to at least one embodiment of the present disclosure.

FIG. 2 displays the architecture of a system for pitching and evaluating scripts according to at least one embodiment of the present disclosure.

FIGS. 3-23 show exemplary screen shots of a graphical user interface generated on a web browser or user device as transmitted from a system and/or generated through implementation of a method according to at least one embodiment of the present disclosure.

### DETAILED DESCRIPTION

The present application discloses various embodiments of a system, and methods for using and constructing the same, for uploading, evaluating, networking, pitching, and submitting a script to agents, producers, movie or television studios, or other industry professionals, who may wish to access or acquire new scripts or new writers and authors. According to one aspect of the present disclosure, an online platform is disclosed that enables a script to be uploaded to the system, evaluated accordingly to predetermined criteria, and assigned a rating, such that the script may be identified via a query of the system using the predetermined criteria. A script may be a play, screenplay, teleplay, or other performance art form that is described in written text. For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure discusses execution of one or more steps of the methods disclosed herein through a script pitching and evaluation system, or script platform, which may be an online platform to which a script, or a portion thereof, may be uploaded, submitted, or otherwise entered. The script platform may have several categories of users, including but not limited to submitters, evaluators, reviewers, industry members, and administrators. The script platform may further include a public user portion and an administration portion, which is accessible only by users designated as administrators. A specific user may interact with the system as more than one category of user depending on the operation performed. For example, a submitter may evaluate, as an evaluator, the script he or she submitted. A script may be evaluated either through an automated comparison of the script with one of several predetermined master scripts or by other users or peers who evaluate the script on various established criteria.

In at least one embodiment of the present disclosure, the script platform may include a user interface through which interested parties including, but not limited to, agents, producers, television and movie studio representatives, and the like (hereinafter generally referred to “industry members”), may access the scripts and information about the submitters and other users of the platform. In at least one embodiment, the platform enables the industry members to interact and communicate with the other users. In at least one embodiment, the platform enables the industry members to request, search for, or access scripts or portions thereof for a more thorough review. In at least one embodiment, the platform may include an online bulletin board and chat area where submitters can interact with other users, agents, producers, or television or movie studio representatives. In such an embodiment, the communications between users may be made public or private by the users and/or administrators.

In at least one embodiment, the script platform may present a user with a user agreement which requires a submitter, who desires or expresses an interest in submitting a script, to agree to the terms and conditions of the script platform by selecting an active link or “button” that says “I Accept” or some similar indication of the user's acceptance or assent to be bound by the terms and conditions of the user agreement. The user agreement may include provisions that provide assurance to industry members, such as agents, producers, and television and movie studio representatives, that the user submitting the script will not bring a lawsuit or otherwise assert any rights against them. If the user does not agree to these terms and conditions, then the user will not be able to upload their script to the system or platform.

In at least one embodiment, potential industry users, such as agents, producers, and television and movie studio representatives, and the like, may be invited to become the industry members of the platform. Membership in the platform may require submission of company information, agreement to certain user terms and conditions for the members, inclusion of a username and password, and other requirements similar to the users. In one embodiment, a qualification process may determine whether potential industry members currently qualify as such. The qualification process may be manual or automated, such as comparison of a name or a company name to a database of known industry companies and personnel. Security may be assured through use of digital keys provided to the industry members or sending full scripts only to corporate e-mails or hard copy scripts to a known physical address.

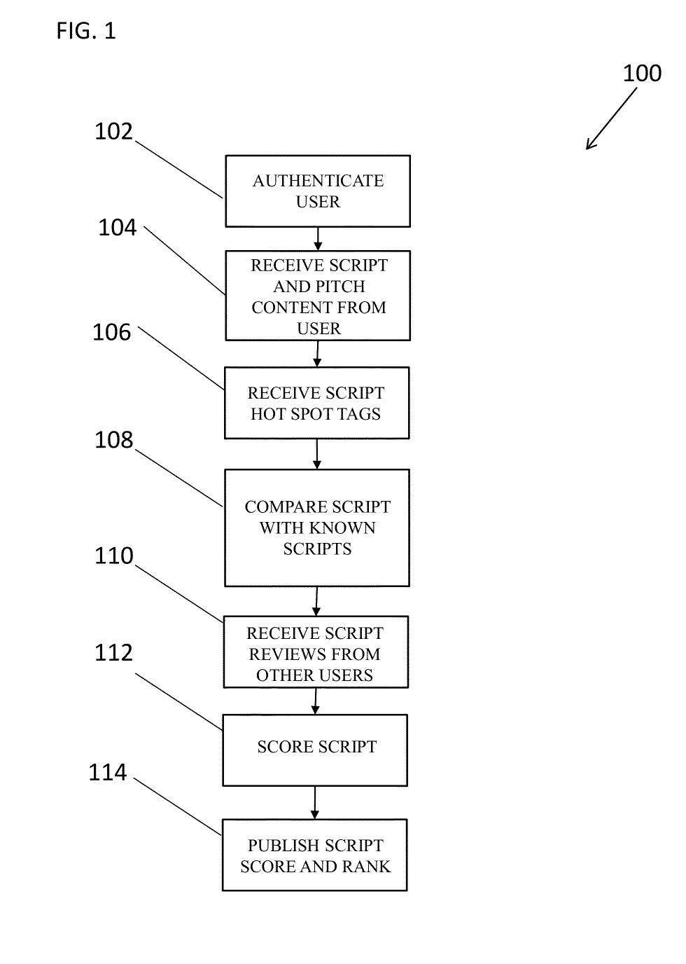

Referring now to FIG. 1, it is shown a flowchart of a method 100 for pitching and evaluating scripts according to at least one embodiment of the present disclosure. As shown in FIG. 1, the method 100 includes authenticating a user in step 102, receiving script and pitch content from the user in step 104, receiving script hot spot tags in step 106, comparing the script with known scripts in step 108, receiving script reviews from other users in step 110, scoring the script in step 112, and publishing the script score and ranking against other scripts in step 114.

In at least one embodiment of the present disclosure, a user of a script pitching and evaluation system attempts to logon and the script pitching and evaluation system authenticates the user's identity in step 102. In such an embodiment, a user may be required to authenticate to the script pitching and evaluation system prior to obtaining access. In some embodiments, the script pitching and evaluation system may request access credentials from a user upon the user's first attempt accessing script pitching and evaluation system through a username and password field, automatically through Kerberos, NTLM, cookie-based authentication, or other automatic authentication negotiation. In response to the authentication request, the user provides access credentials and/or otherwise authenticates to his or her identity. In such an embodiment, the user device may authenticate by providing a username and password, referencing a previously generated session (i.e. through a cookie), through a third-party authentication provider (i.e. OAuth, openid, or others), providing a trusted certificate, token or other one-time pad resource in addition to PIN, or other authentication mechanism.

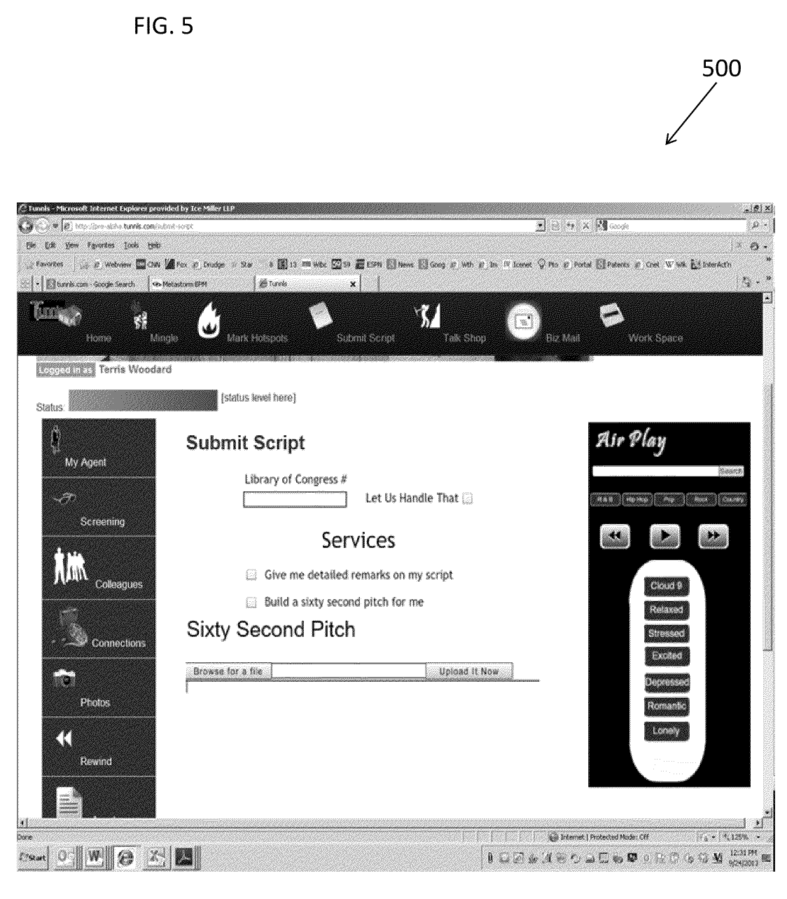

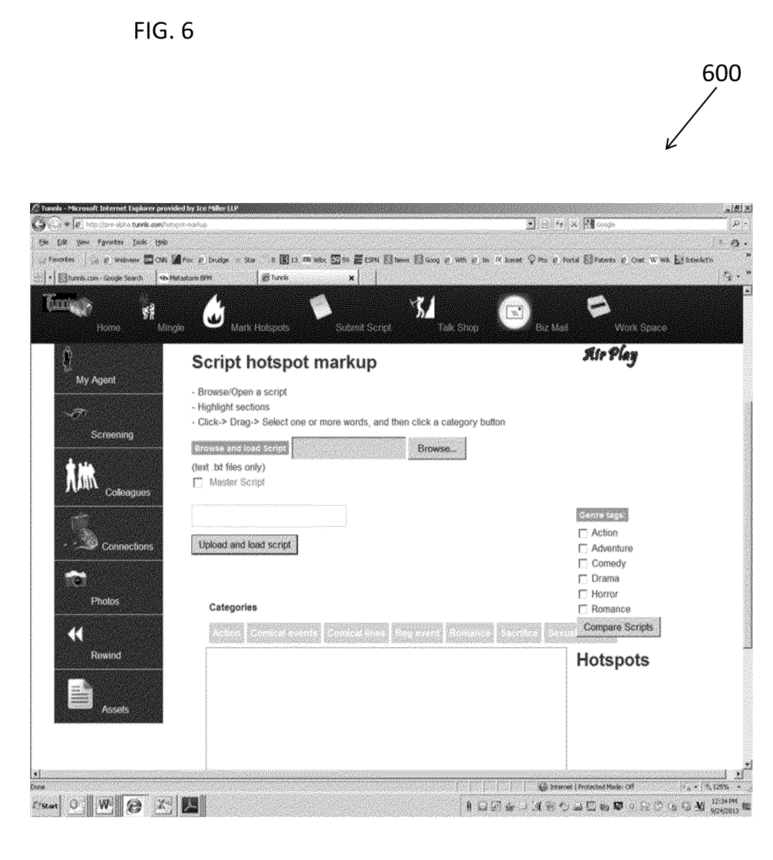

In at least one embodiment of the present disclosure, the script pitching and evaluation system receives a script and pitch content from a user through a computer network in step 104. In such an embodiment, a user transmits a script through the script pitching and evaluation system over the Internet. A script may be pulled from publicly available resources identified by the user, like the Library of Congress, the United States Copyright Office, YouTube, or other publicly available resources through a reference number, such as, for example, as shown in the graphical user interface 500 shown in FIG. 5. A script may also be uploaded through an upload feature of a web browser or user device, such as, for example, the graphical user interface 600 displayed in FIG. 6.

The user may upload the script in a variety of formats, such as, for example, PDF, Word-accessible format, an audio file (i.e. .wav, .mp3), a video file (i.e. .mkv, .mp4), or even a reference to publicly accessible content as discussed above. Upon submission of a script in step 104, the script platform may enable the user to submit pitch content, like text of a brief description of the script or to make an audio recording of the brief description. Pitch content may further include a video or other multimedia content. In an exemplary embodiment, the pitch content may include a sixty-second video of the author of the script which purports to sell the concept of the script to potential reviewers, similar to the experience an author would have in a face-to-face meeting with a producer.

In at least one embodiment of the present disclosure, the platform may further enable the submitter to identify “hot spots” within their scripts in step 104. In step 104, the user is . Hot spots may be particularly relevant or interesting portions of the script as identified, or “tagged,” by the submitter.

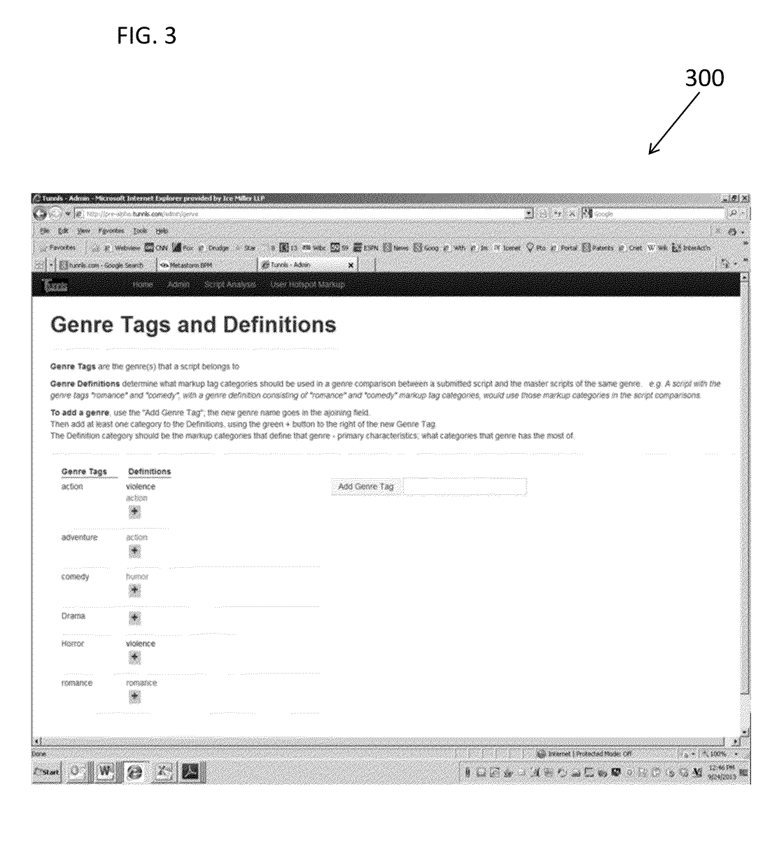

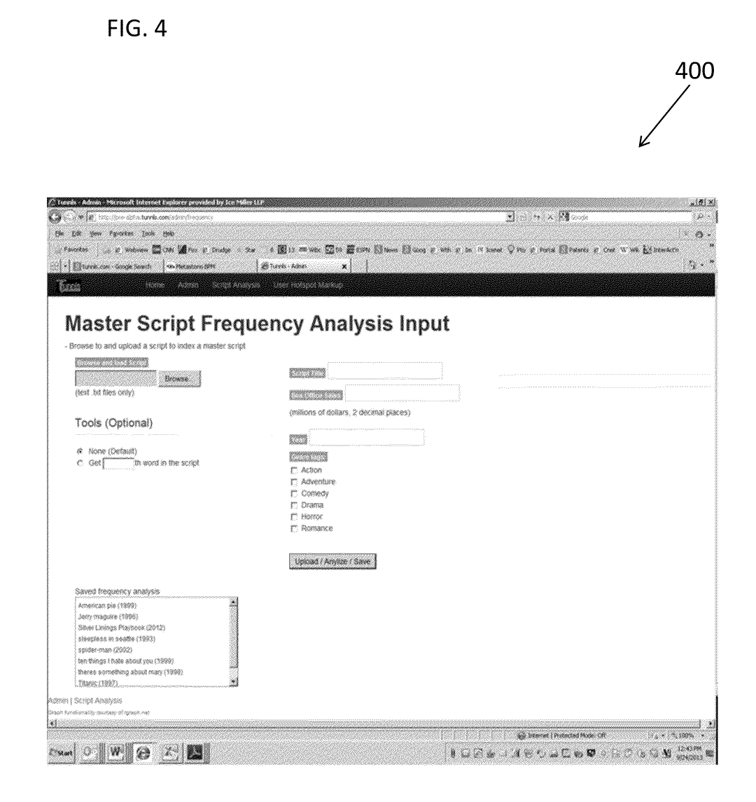

In at least one embodiment of the present disclosure, an administrator identifies tags for hot spots based on criteria, such as, for example, genre. Tags may further include sub-tags and/or descriptions for each tag. For example, as shown in the graphical user interface 300 displayed in FIG. 3, genre tags may include action, adventure, comedy, drama, horror and romance with action having a ‘violence’ definition, adventure having an ‘action’ definition, comedy having a ‘humor’ definition and so forth. It should be appreciated that tags and definitions may be used in a genre comparison between a submitted script and one or more known scripts in the same genre. For example, a script with the genre tags “romance” and “comedy,” with a genre definition consisting of “romance” and “comedy” markup tag categories, would use those markup categories in the script comparisons between the submitted script and one or more known scripts. Tags, then, may be used to categorize submitted scripts against scripts already uploaded and/or known to the platform.

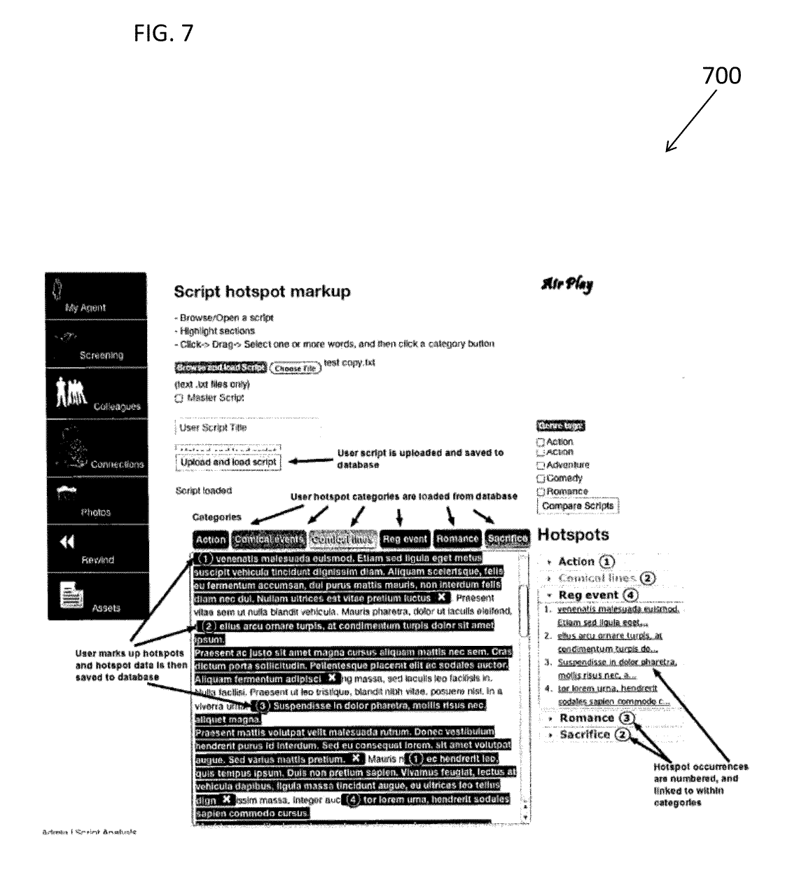

In step 106, the user may tag an uploaded script. In such an embodiment, the user may generally tag the script with one or more tags and descriptions and/or the user may tag sections of the script. FIG. 6, for example, shows a graphical user interface 600 where a user may upload or select a known script for hotspot tagging. The graphical user interface 700 shown in FIG. 7 shows one example of a user tagging hotspots of a script based on categories. In this example, the user has selected sections of the script related to one or more hotspot categories which are numbered and referenced in the graphical user interface 700. For example, the hotspot labeled as (1) is related to “action,” the hotspot labeled (2) is related to “comical lines,” and the hotspot labeled (3) is related to “romance.” It should be appreciated that sections and/or lines of a script may have multiple tags. In at least one embodiment of the present disclosure, hotspots tagged in step 104 are inserted into a database associated with the system.

In at least one embodiment according to the present disclosure, one or more master scripts may be uploaded by an administrator. Upon uploading the master script, the administrator may initiate an analysis of the master script to establish the standards (or the baseline) against which submitted scripts or portions of scripts will be compared. In another embodiment, the submitter may submit a renowned script that the submitter wishes the submitted script to be compared against, such as when the user is attempting to emulate the style of a given successful writer.

Baselines for master scripts may be established using a variety of analytic techniques on a variety of categories of parts, features, or characteristics of the master scripts. In at least one embodiment, an analysis is performed on portions of the text of a master script that are marked for analysis. In another embodiment, the entire script may be analyzed. The analysis may use various criteria, including without limitation phrases or word or root word frequency, key word usage and/or frequency, inclusion of categories such as action, explicit language or other content, humor, romance, sexual content, suspend, violence, and the like. In at least one embodiment, the script platform may enable other types analyses, including marking certain sections of a master script so that the amount of the script that is dedicated to a specific genre, for example romance, may be color coded and tagged for analysis or later comparison with submitted scripts. The color coding feature facilitates the review and analysis of the designated portions of the master scripts. In at least one embodiment, the color coding feature of categories by the administrator may coincide with the color coding that the submitter of the script may use to tag hot spots and otherwise categorized the various portions of the script. It is within the scope of this disclosure to include in the analysis different analytical techniques for different categories as determined by the administrator. For example, for a humorous section of a script, the setting of the scene and use of certain words and phrases at a particular frequency may be considered an indication of a very humorous portion of a script, while lower overall word counts and fairly lengthy action sequences may be considered an indication of an excellent action sequence.

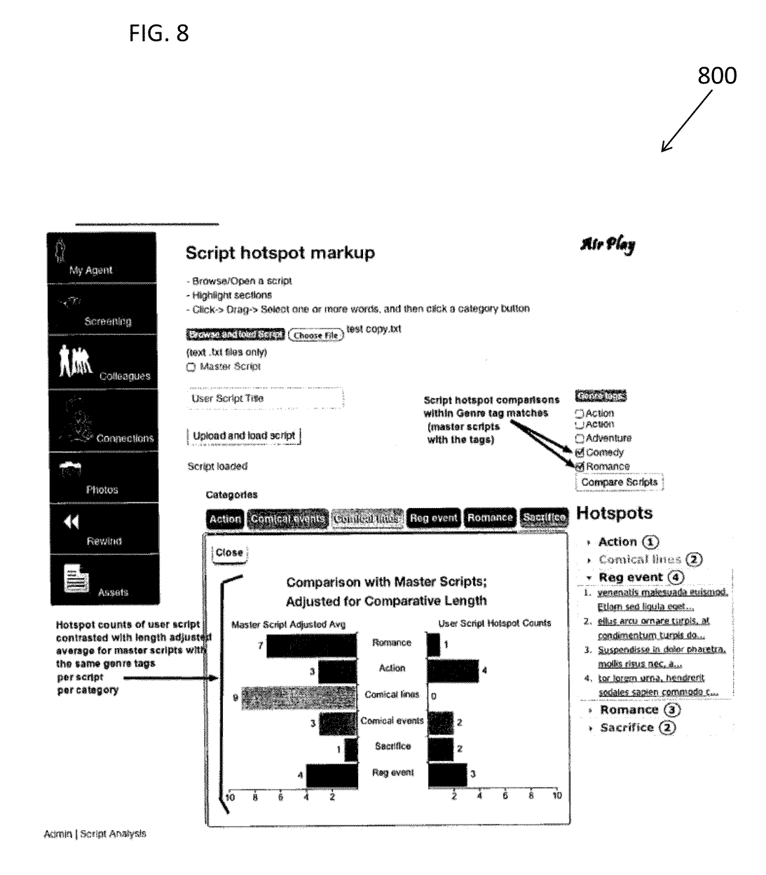

In at least one embodiment of the present disclosure, the tagged script is compared with known scripts to the system in step 108. In such an embodiment, an administrator and/or other users have uploaded scripts and master scripts through the system which reside in a database or other file repository. In such an embodiment, these other scripts have also been tagged with hotspots. In step 108, the tagged script is compared against all known scripts with overlapping tags or known scripts based on tags selected by the user. For example, a script tagged by the user for ‘comedy’ may be compared to all other scripts also tagged with ‘comedy.’ In such an embodiment, the comparison displays how many hotspots are similarly tagged between the uploaded script and a master script and/or known scripts. In some embodiments, the master script and known scripts are averaged to find a balance of tags for comparison purposes. One such example is shown in graphical user interface 800 in FIG. 8. For example, as shown in FIG. 8, the master script adjusted average includes seven “romance” tags and 3 “action” tags. In this example, a master script average is compared against the uploaded script which only includes one “romance” tag and four “action” tags.

Script comparison can serve a variety of purposes for an author. First, master scripts may be uploaded by an administrator and include highly successful and/or award-winning scripts (i.e. Gone With the Wind). When tagging these highly successful master scripts which are compared against uploaded scripts, an author can see how his or her script compares against something that has been successful. For example, if an uploaded script has three “action” hot spots and four “romance” hot spots but the master script has five “action” hot spots and only one “romance” hot spot, then the author may tweak his or her story to fit with the highly successful model.

As discussed above, the comparison may be run against a master script average. For example, the most successful romantic comedies of the last forty years could be uploaded to the system and tagged. After tagging, the system may generate an average for these successful romantic comedies that may provide a road map to an author in structuring his or her story. For example, if the average successful romantic comedy includes six “comedy lines” hot spots, the author may tweak his or her story to add or remove “comedy lines” hot spots to try to match the successful average of scripts in his or her genre.

In another example, the user may choose a specific script or set of scripts in an average for comparison when the user is trying to emulate a known author. For example, if the user wants to write a script that feels like a Stephen King novella, the user may compare his uploaded script against one or more known Stephen King scripts that have been previously tagged. When the comparison runs, the user can immediately see whether his or her script matches the formula used by Stephen King in his works.

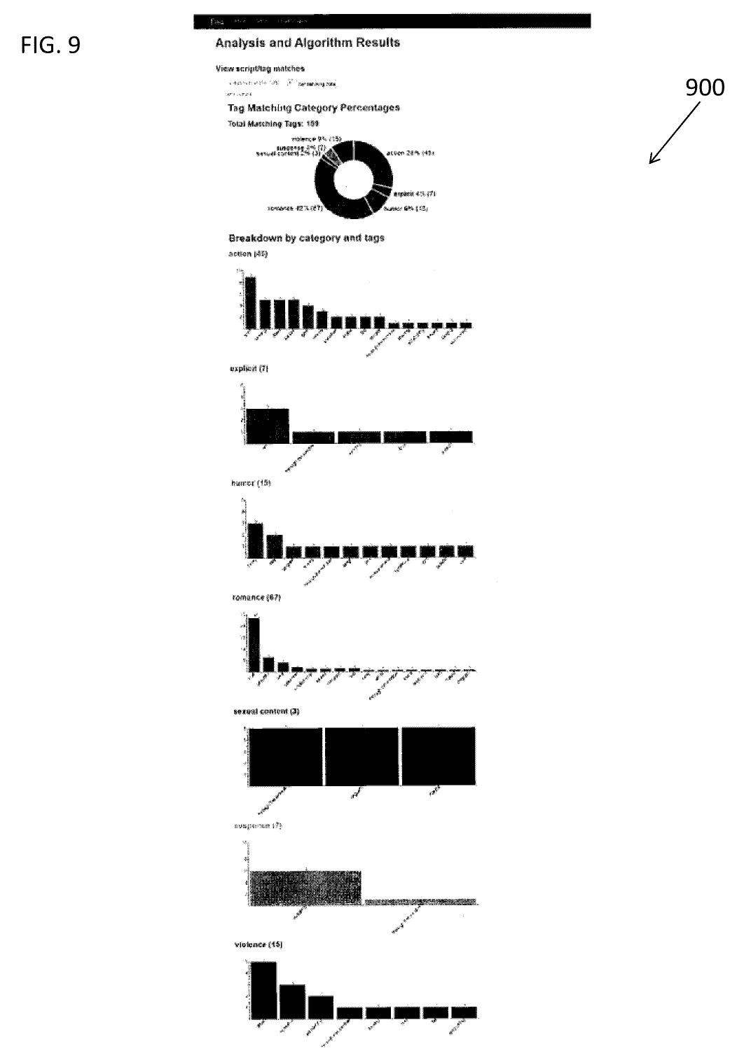

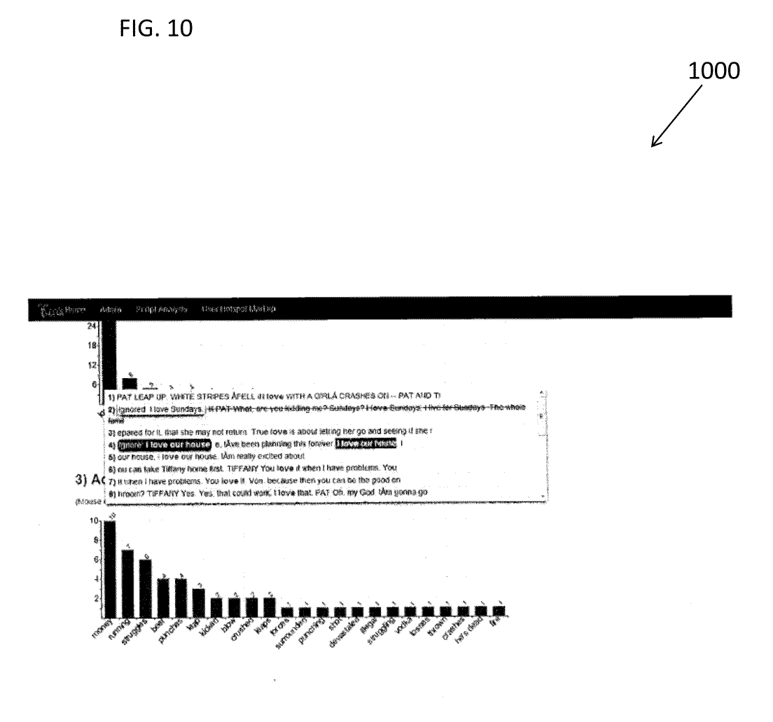

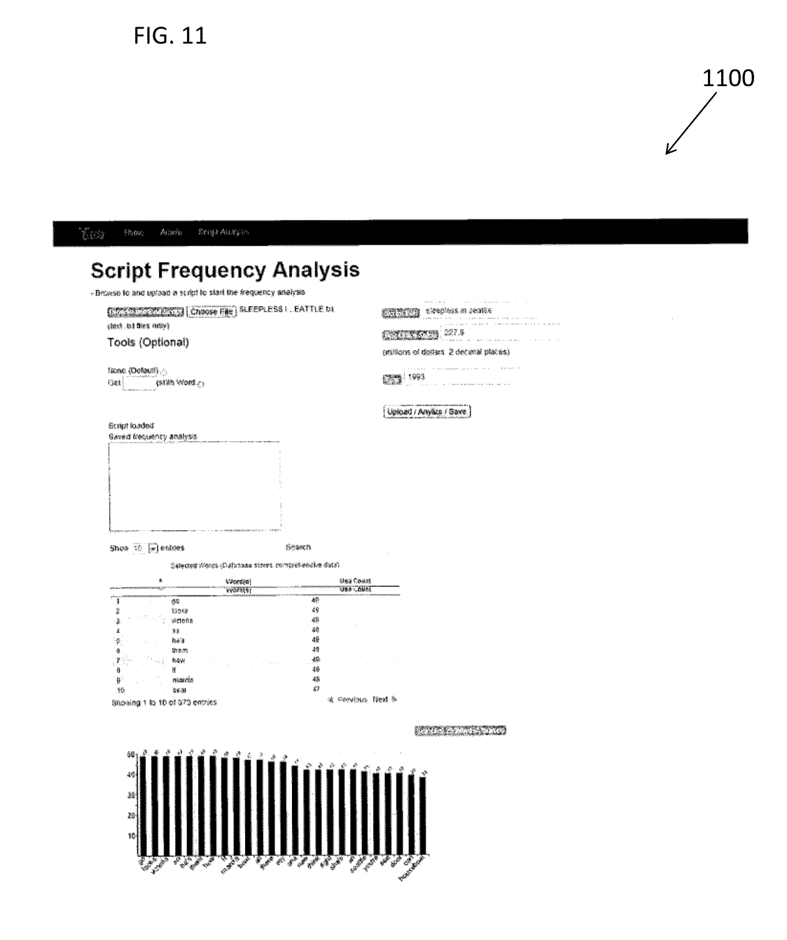

It should be appreciated that the system may provide detailed metrics to the user about the comparison between the uploaded script and the master script or master script average. For example, as shown in the graphical user interface 900 in FIG. 9, the graphical user interface 1000 in FIG. 10, and the graphical user interface 1100 in FIG. 11, the metrics may include a breakdown of tags against known works.

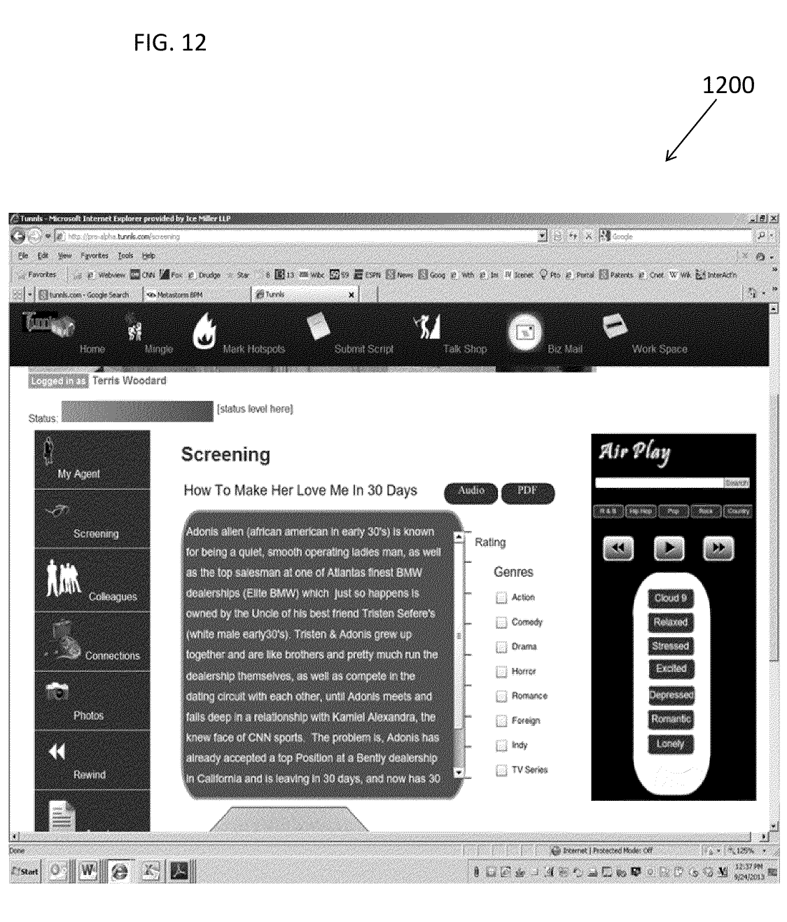

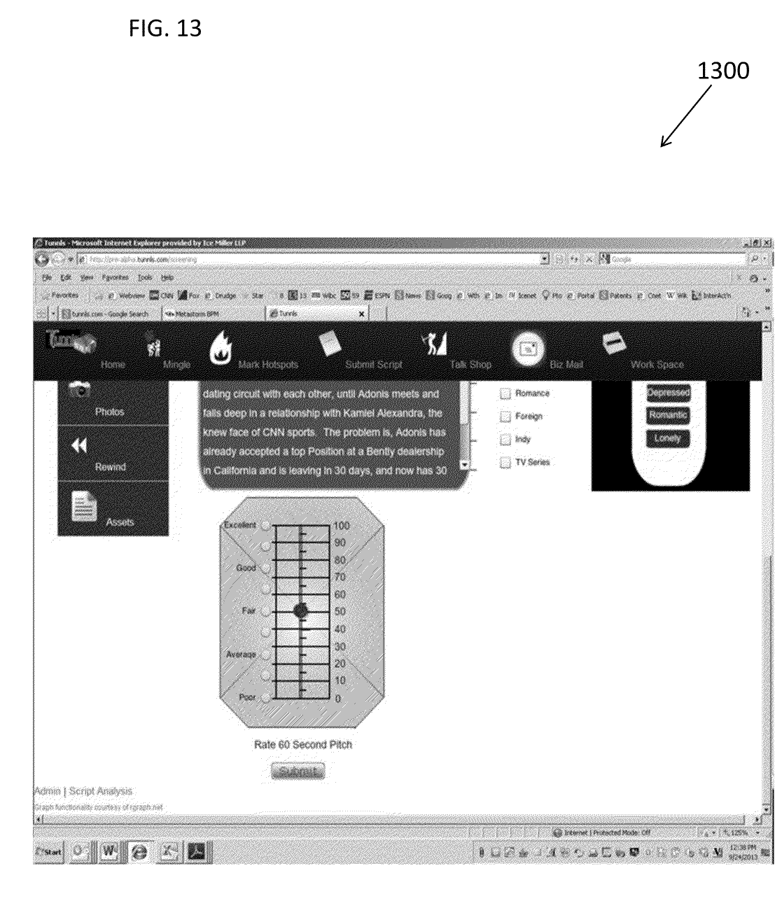

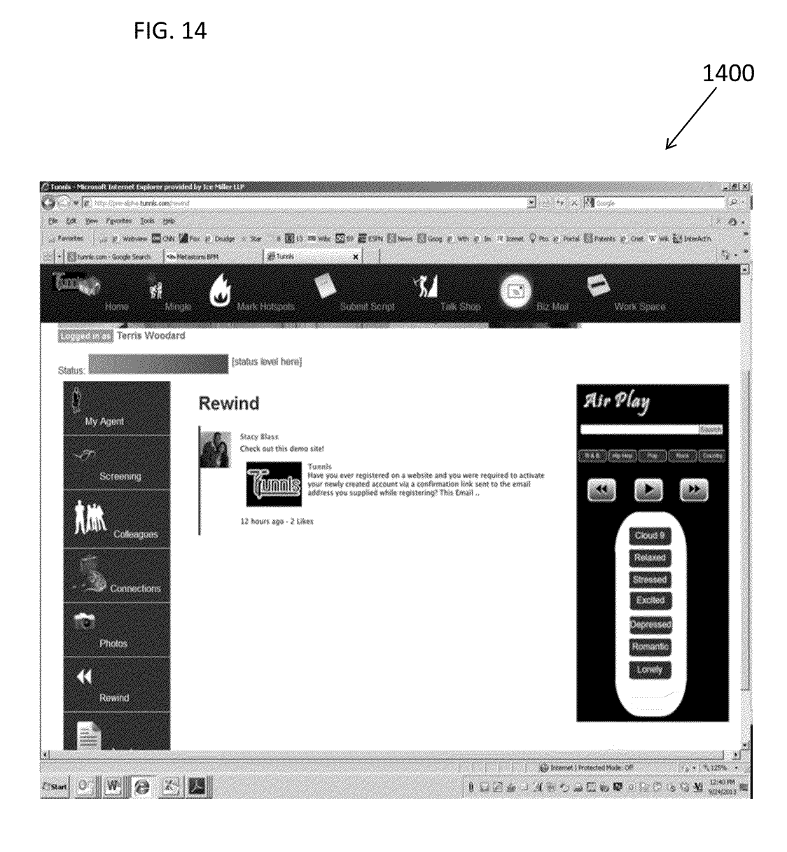

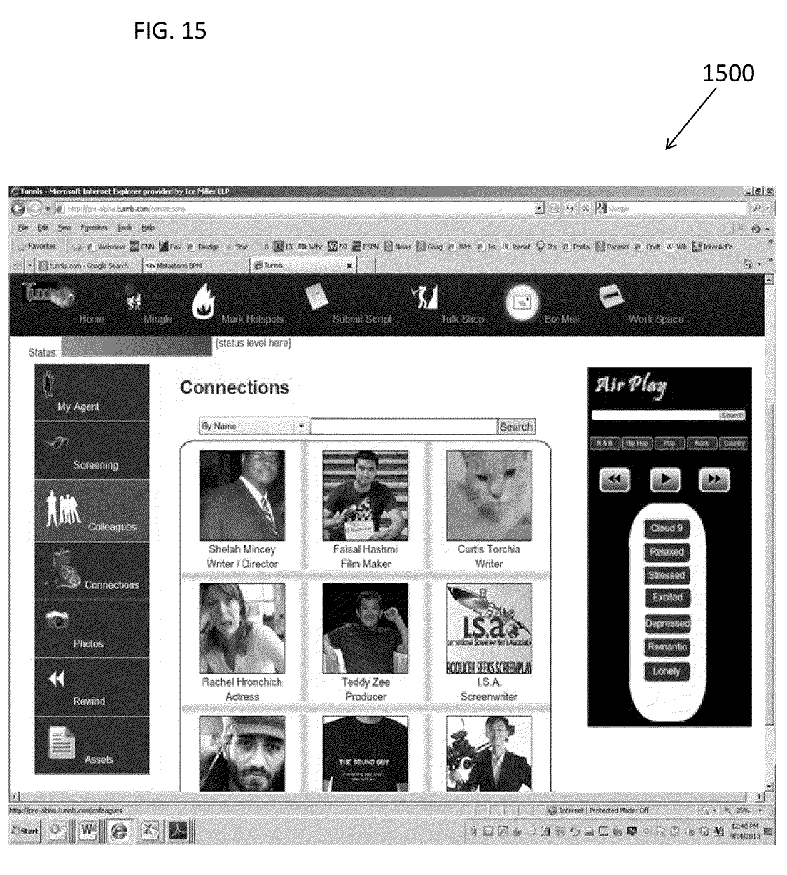

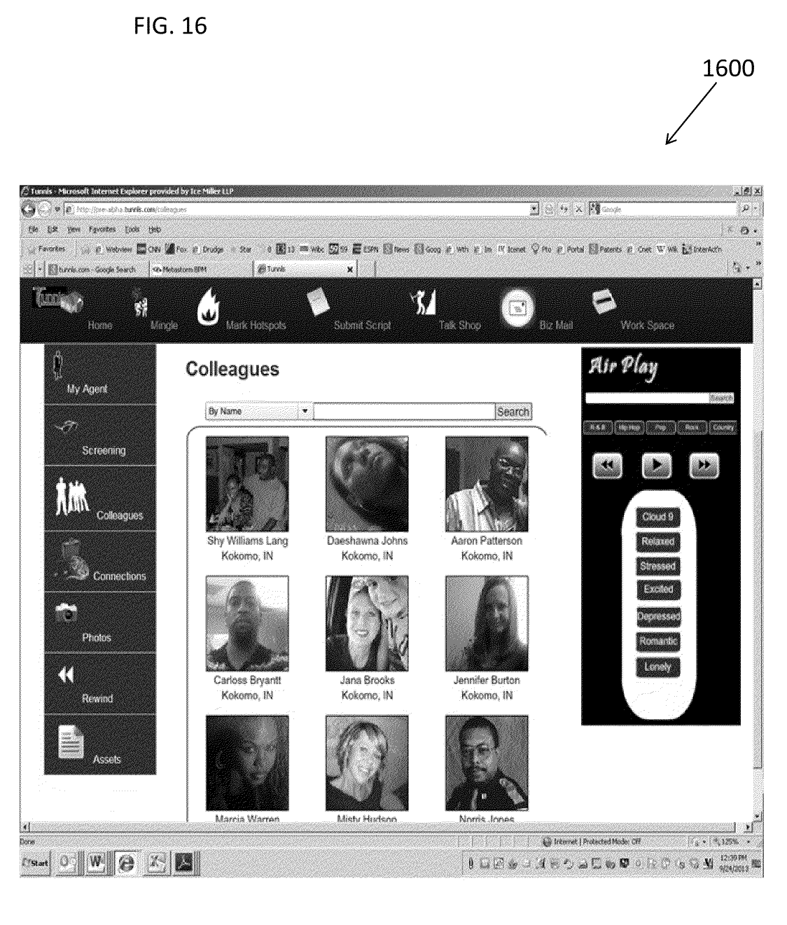

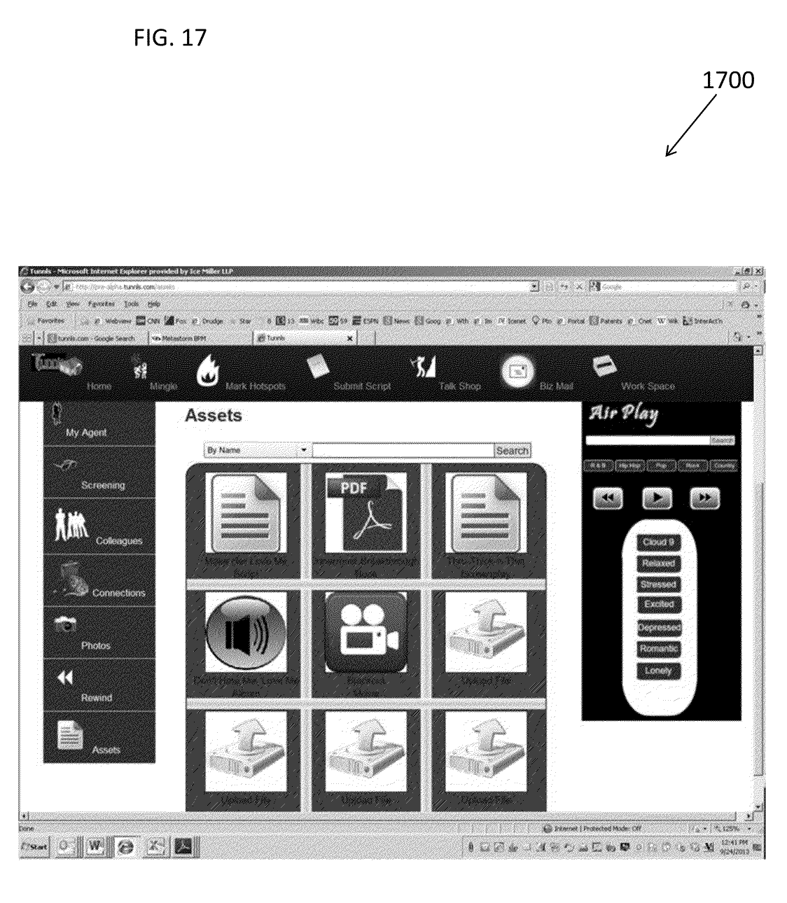

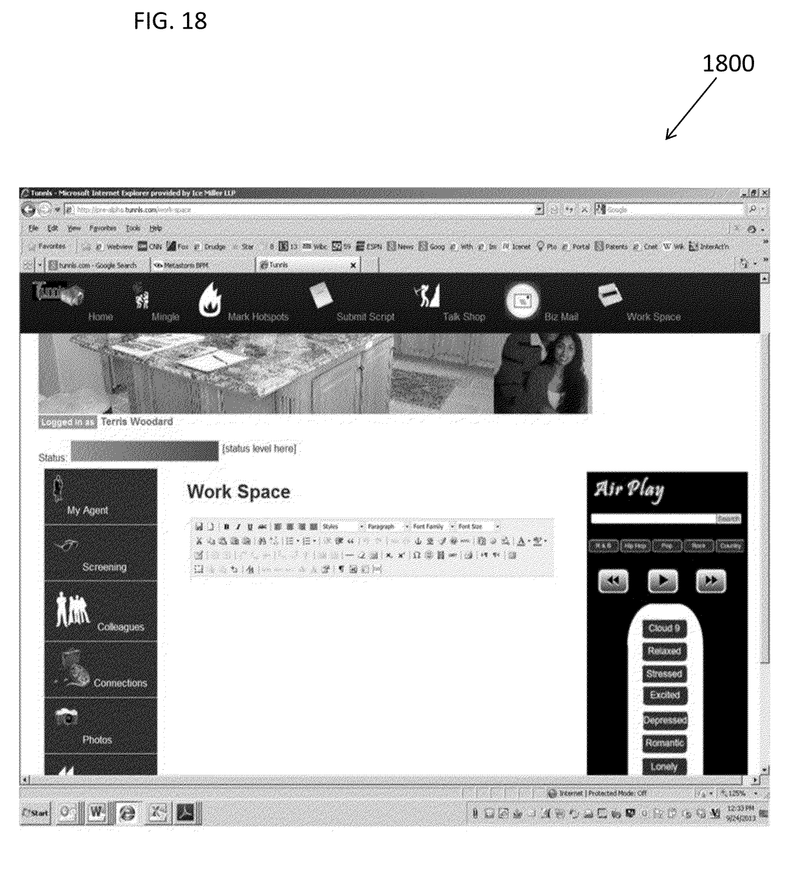

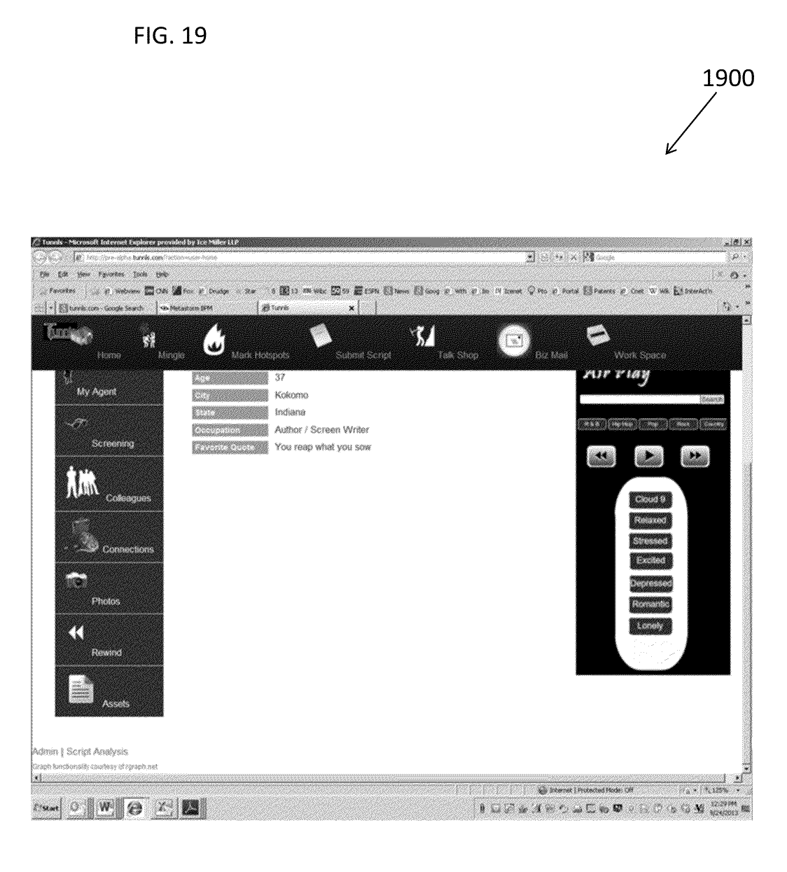

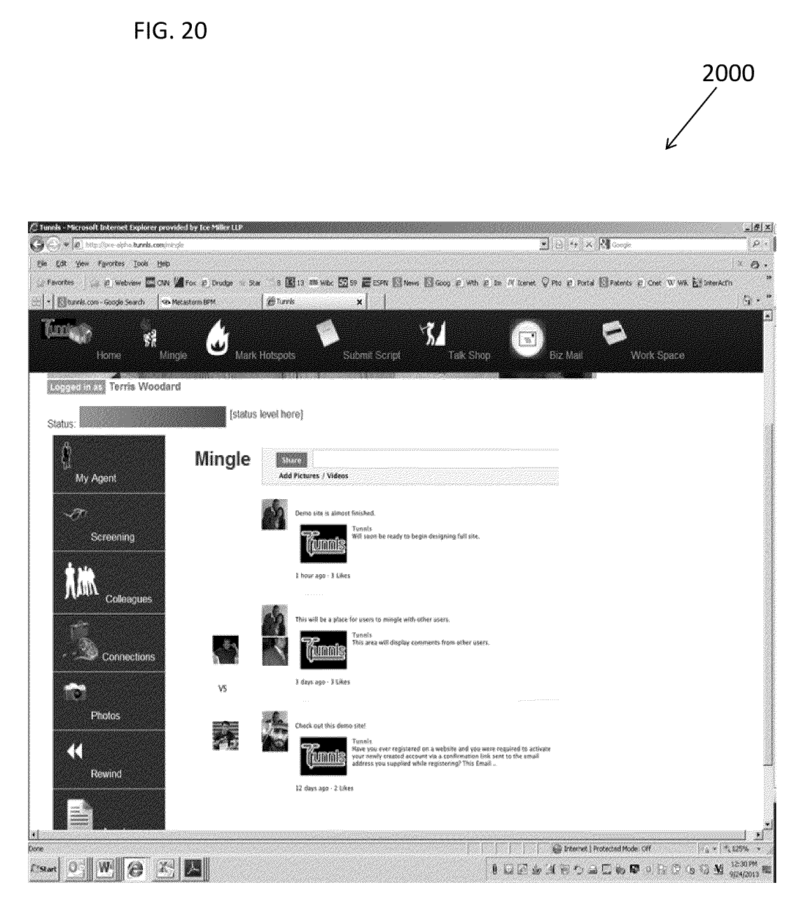

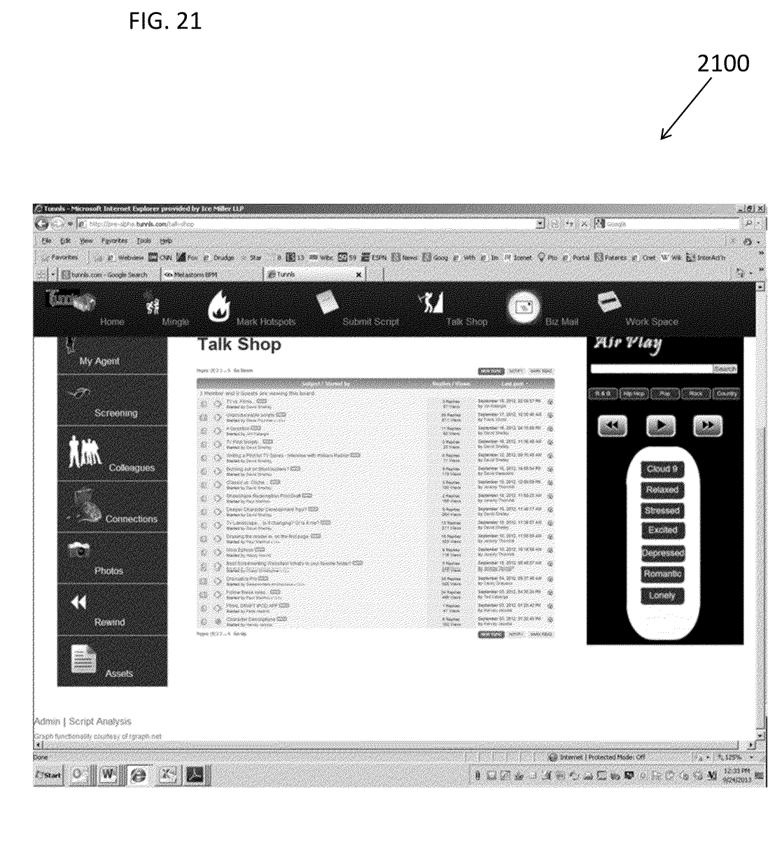

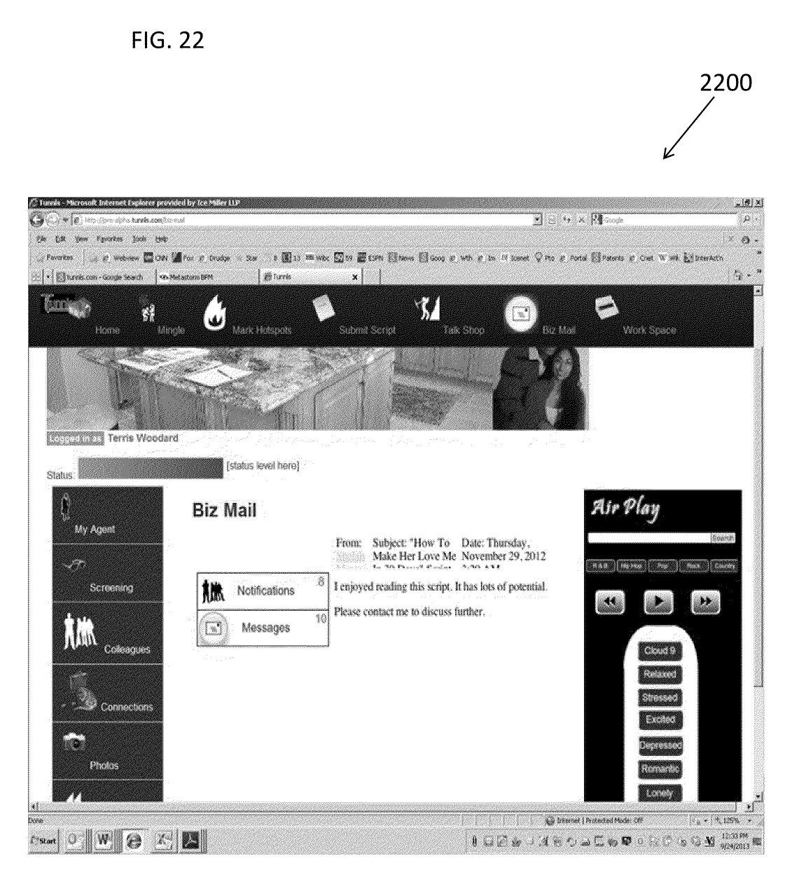

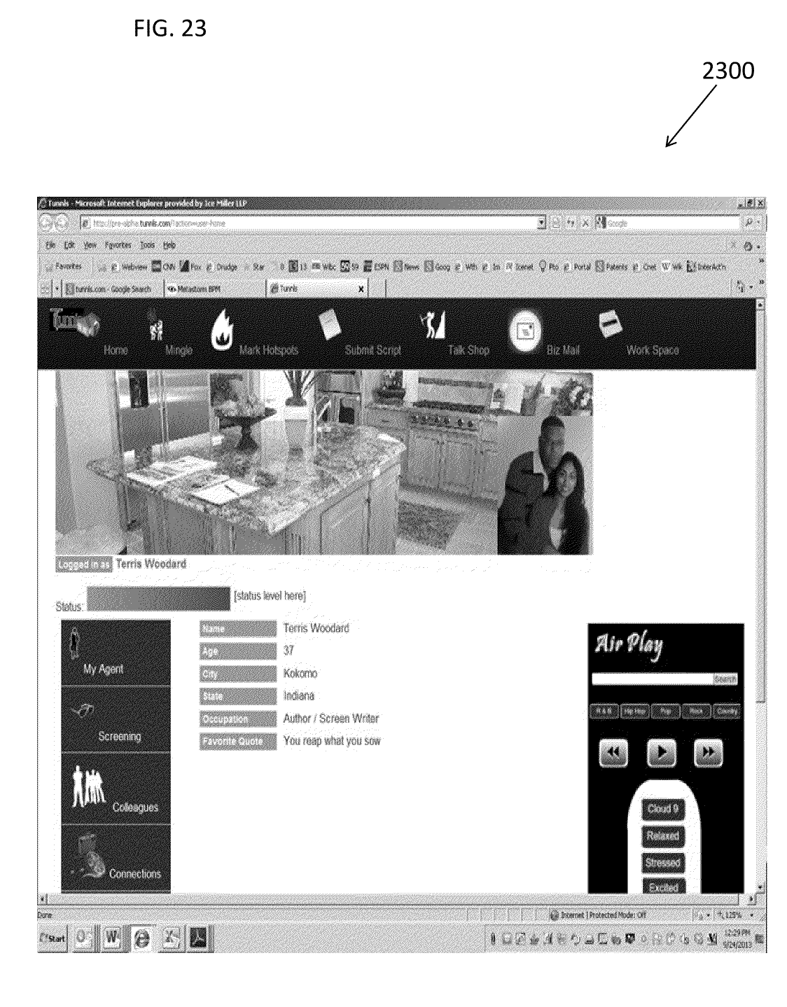

In at least one embodiment of the present disclosure, the method 100 includes receiving script reviews from other users. In such an embodiment, other users of the platform may elect to review, tag, give ratings to, and provide feedback to scripts uploaded by other users. This social aspect of the platform helps collectively review scripts within the system so that the best scripts can be identified. It should be appreciated that today producers review treatments individually and make decisions independently whereas the platform described herein with reviews from users of a social networking platform provides a more accurate rating system of how the script is received by the public. Individual tags and ratings made by other users is inserted into a database for aggregation with all ratings and tags within the system for that particular script. One example of a script review graphical user interface 1200 is shown in FIG. 12. Another example of a script review graphical user interface 1300 is shown in FIG. 13. In both examples, a user may review another user's script through the platform and assign various tags (i.e. “romance”) and a rating to the script which is stored in a database.

In at least one embodiment, the industry members may search for or request scripts to be sent to them which satisfy certain criteria. Such criteria may include authors that have a 90% or higher positive (or some other measure) rating, or romantic comedy scripts having a comedy value of 90% or higher. In such an embodiment, only those scripts and authors meeting the selected criteria could submit scripts via the platform. In another aspect of such an embodiment, the platform may be configured to automatically connect the industry member with scripts meeting selected criteria. For example, the top ten scripts ordered in some fashion such as hottest writer, newest script, highest peer ranking, or highest automated ranking when compared to the master script, or a master script selected by the industry member, may be automatically sent to the industry member. Although percentage positive ratings are disclosed, any suitable measure could be employed, including without limitation a ranking from 1 to 10, a like or dislike indication, tallies of such likes or dislikes, a color coded system, and the like.

In at least one embodiment of the present disclosure, the method 100 includes scoring a script in step 112. In such an embodiment, all user ratings of a script are stored within a database associated with the system and aggregated to generate an overall user score. In such an embodiment, the overall user score is an average of all scores submitted within the system. In step 114, the overall user score may be compared with other user scores for other scripts and published through the platform as a ranking, the ranking identifying where an individual script falls in the top list of scored scripts on the system. It should be appreciated that a ranking may identify which scripts should be reviewed by a producer for creation of a project.

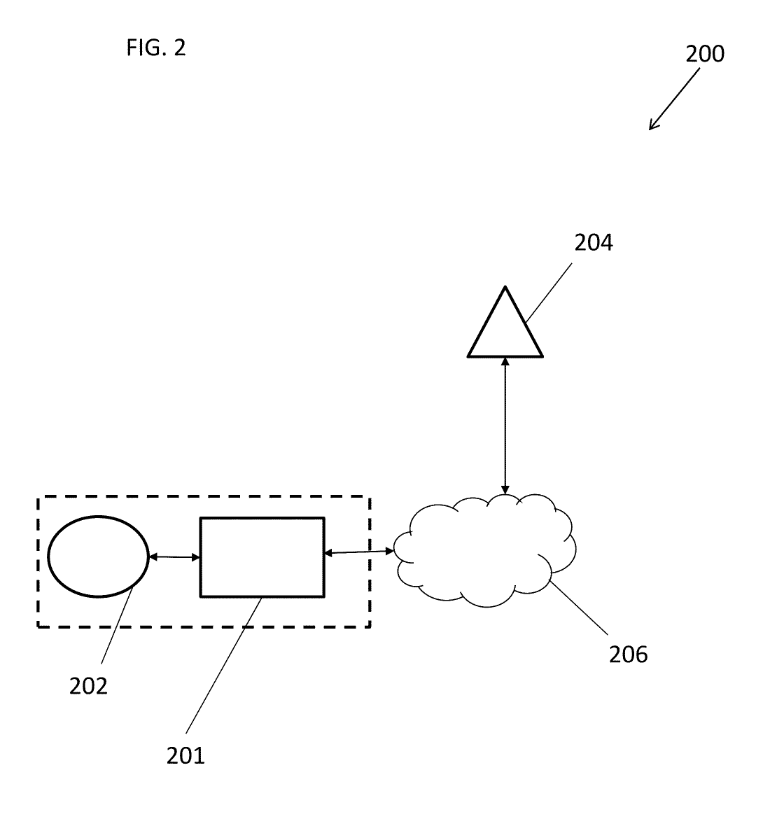

Referring now to FIG. 2, it is shown components of an architecture in a system 200 for pitching and evaluating scripts. As shown in FIG. 2, the system includes a server 201, a database 202, a user device 204, and a computer network 206. In addition, FIG. 2 shows computer network 206 as the Internet, but this is not required.

The user device 204 may include, but is not limited to, a computer, smartphone, tablet, computing device, or system of a type well known in the art for performing computing operations. Although not shown in FIG. 2, user device 204 further includes software, hardware, and other components necessary to perform standard user functions, like an operating system, web browser, keyboard, mouse, memory systems, processors, device controllers, and the like. One of ordinary skill in the art would appreciate that user device 204 may include any type of consumer and/or business computing device, like an iPad, iPhone, Samsung Galaxy s4, laptop, desktop, Microsoft Surface Pro 3, etc.

The user device 204 is further configured to provide input to the server 201 to carry out one or more of the steps of the methods described herein. Server 201 comprises one or more server computers, computing devices, or systems of a type known in the art. Server 201 further comprises such software, hardware, and componentry as would occur to one of skill in the art, such as, for example, microprocessors, memory systems, input/output devices, device controllers, display systems, and the like. Server 201 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 2, server 201 is shown and referred to herein as a single server. However, server 201 may comprise a plurality of servers, virtual infrastructure, or other computing devices or systems interconnected by hardware and software systems know in the art which collectively are operable to perform the functions allocated to server 201 in accordance with the present disclosure.

The database 202 is configured to store scripts, user information, ratings, tags, administrative information, and other information. Database 202 may reside on server 201 or be part of the same infrastructure as server 201, such as, for example, a virtual infrastructure, a private network, or the like. Database 202 may also communicate with server 201 through computer network 206, although this is not shown. Database 202 may be standalone infrastructure independent from server 201.

For purposes of clarity, database 202 is shown in FIG. 2, and referred to herein as a single database. It will be appreciated by those of ordinary skill in the art that database 202 may comprise a plurality of databases connected by software systems of a type well known in the art, which collectively are operable to perform the functions delegated to database 202 according to the present disclosure. Database 202 may comprise a relational database architecture or other database architecture of a type known in the database art. Database 202 may comprise one of many well-known database management systems, such as, for example, MICROSOFT's SQL Server, MICROSOFT's ACCESS, or IBM's DB2 database management systems, or the database management systems available from ORACLE or SYBASE. Database 202 retrievably stores information that are communicated to database 202 from user device 204 or server 201.

User device 204 and server 201 all communicate via computer network 206. If database 202 is in disparate infrastructure from server 201, database 202 may communicate with server 201 via computer network 206. Computer network 206 may comprise the Internet, but this is not required.

While various embodiments of a system for uploading, evaluating, networking, pitching, and submitting a script to agents, producers, movie or television studios, or other industry professionals, who may wish to access or acquire new scripts or new writers and authors and methods for using and constructing the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A computer implemented system used to facilitate the upload, evaluation, and submission of a script, the system comprising:
a first server, the first server configured to receive a script uploaded by a user; and
a processor, either associated with the server or operably connected to the server, the processor adapted to review the script, wherein the processor reviews the script:
automatically in comparison to a master script including benchmark data associated therewith, and/or
manually, wherein one or more users of the system review the script via the processor; and/or
manually, wherein one or more industry users of the system review the script via the processor.

2. The system of claim 1, wherein the system further comprises a feature enabling an industry user to request scripts of a particular type or genre and/or specify particular criteria to view scripts satisfying the criteria and/or being put into contact with a user of the system who has uploaded scripts satisfying the criteria.

3. The system of claim 1, wherein the system further comprises a public user portion and administrator portion.

4. The system of claim 1, wherein the one or more users of the system may identify hot spots.

5. The system of claim 4, wherein the hot spots are color coded.

6. A computer implemented system used to facilitate the upload, evaluation, and submission of a script, the system comprising:
a first server, the first server configured to receive a script uploaded by a user; and
a processor, either associated with the server or operably connected to the server, the processor adapted to review the script, wherein the processor reviews the script:
automatically analyzing the script for criteria including frequency of key word usage, and/or
manually, wherein one or more users of the system review the script via the processor; and/or
manually, wherein one or more industry users of the system review the script via the processor.

7. The system of claim 6, wherein automatically analyzing the script for criteria includes the use of categories.

8. The system of claim 7, wherein the criteria are color coded.

9. The system of claim 7, wherein the analysis of the scripts and the script itself is stored in a database of scripts.

10. The system of claim 9, wherein the database can be searched by unique criteria.

11. A computer implemented system used to facilitate the upload, evaluation, and submission of a script, the system comprising:
a first server, the first server configured to receive a script uploaded by a user; and
a processor, either associated with the server or operably connected to the server, the processor adapted to review the script, wherein the processor reviews the script:
automatically in comparison to a master script including benchmark data associated therewith, and/or
manually, wherein one or more users of the system review the script via the processor; and/or
manually, wherein one or more industry users of the system review the script via the processor; and/or
storing, the reviewed script and benchmark data in a database.

12. The system of claim 11, wherein the database can be searched by benchmark data.

13. The system of claim 11, wherein automatically scripts which satisfy certain criteria are automatically delivered to the requesting industry user

14. The system of claim 11, wherein scripts may only be submitted upon exceeding a given benchmark criteria.

15. The system of claim 11, wherein benchmark data includes a rating between one and ten.
